(19) United States
(12) Patent Application Publication
(10) Pub. No.: US 2006/0133236 A1
(43) Pub. Date: Jun. 22, 2006

(54) Tracking control method and apparatus and image capture method and apparatus for holographic information recording medium

(75) Inventors: Ji-deog Kim, Seoul (KR); Bong-sik Kwak, Seoul (KR); Chung-woo Lee, Seoul (KR); Chung-choo Chung, Seoul (KR); Sang-han Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/189,726

(22) Filed: Jul. 27, 2005

(30) Foreign Application Priority Data
Dec. 16, 2004 (KR) 10-2004-0107162

(51) Int. Cl. G11B 7/00

(52) U.S. Cl. 369/44.41; 369/103

(57) ABSTRACT

Provided is a method of controlling tracking of an information recording medium including an area for storing a holographic image and an area for storing servo spots formed discretely and at a predetermined interval, which is achieved by obtaining an RF-SUM signal by adding all of detection signals of a quadrant photodetector for detecting the servo spot, monitoring whether the RF-SUM signal exceeds a predetermined level, and performing tracking control in a section where the RF-SUM signal exceeds the predetermined level. Also provided is a related apparatus.

### CROSS-REFERENCE TO RELATED PATENT APPLICATIONS

This application claims the benefit of Korean Patent Application No. 10-2004-0107162, filed on Dec. 16, 2004, in the Korean Intellectual Property Office, the disclosure of which is incorporated herein in its entirety by reference.

### BACKGROUND OF THE INVENTION

1. Field of the Invention

Apparatuses and methods consistent with the present invention relate to reproducing holographic information stored on a recording medium, and more particularly, to a method and apparatus for tracking control of a holographic information recording medium and a method and apparatus for capturing an image from the holographic information recording medium.

2. Description of the Related Art

A holographic recording method is used to record information on an optical recording medium using a hologram at an ultrahigh density. According to the holographic recording method, an interference pattern is generated in the optical recording medium by allowing a signal beam containing image information to interfere with a particular reference beam. That is, the interference pattern is recorded on the optical recording medium so that the image information is recorded. To reproduce information from the recorded interference pattern, a reproduction reference beam similar to the beam used for recording is emitted onto the interference pattern recorded on the optical recording medium. This emission causes diffraction by the interference pattern so that the image information is reproduced. In a volume holography, high density information recording is possible as a hologram is recorded to be overlapped on the volume of the optical recording medium by changing a physical property of the reference beam.

FIG. 1 shows the format of storing a holographic image on an information recording medium according to a conventional technology. Referring to FIG. 1, an interference pattern obtained by interference between a signal beam having information and a reference beam is recorded along a particular track on a holographic information recording medium. An image reproduced from the interference pattern includes a holographic data image in units of pages and servo spots. In a reproduction apparatus, a photodetector detects the position of servo spots to detect an image capture time point and perform tracking. Also, the servo spot is used to correct the position of the reference beam.

When the holographic image is read out from a disk, the read images may be defocused, shifted, rotated, or distorted, which is due to disk wobbling, the decenter of the disk from a rotation shaft, or the deformation of the disk. These defects cause errors to signals measured by a detector or deteriorate quality of the signals.

Unlike a typical compact disc in which each data is formed into a single pit, each image can contain several hundreds of thousands of pixels in a disk containing data as holographic images. Typically, an array having several hundreds of thousands of detection devices is provided to measure a single holographic image. All pixels not only for a single holographic image but also for all holographic images of the disk need to be accurately focused and located at accurate positions in relation to a detection array. However, it is difficult to accurately arrange numerous pixels in the holographic image.

### SUMMARY OF THE INVENTION

To address the above and/or other problems, the present invention provides a tracking control method and apparatus and an image capture method and apparatus for accurately reproducing two dimensional information from an information recording medium containing a holographic image, through tracking control and a shuttering signal.

According to an aspect of the present invention, a method of controlling tracking of an information recording medium including an area for storing a holographic image and an area for storing servo spots formed discretely and at a predetermined interval comprises obtaining an RF-SUM signal by adding all of detection signals of a quadrant photodetector for detecting the servo spot, monitoring whether the RF-SUM signal exceeds a predetermined level, and performing tracking control in a section where the RF-SUM signal exceeds the predetermined level.

The method further comprises turning off the tracking control when the RF-SUM signal is not more than the predetermined level.

According to another aspect of the present invention, a method of controlling tracking of an information recording medium including an area for storing a holographic image and an area for storing servo spots formed discretely and at a predetermined interval comprises obtaining a shuttering signal by subtracting a sum of values of signals of third and fourth photodetection devices from a sum of values of signals of first and second photodetection devices, in a direction in which the information recording medium rotates, from detection signals of a quadrant photodetector for detecting the servo spot, monitoring whether the shuttering signal belongs to a predetermined section, and performing tracking control in a section where the shuttering signal belongs to the predetermined section.

The predetermined section includes a section from a time point indicating a maximum value of the shuttering signal to a time point indicating a minimum value of the shuttering signal.

The method further comprises turning off the tracking control when the shuttering signal is out of the predetermined section.

According to another aspect of the present invention, a method of capturing a holographic image from an information recording medium including an area for storing a holographic image and an area for storing servo spots formed discretely and at a predetermined interval comprises obtaining a shuttering signal by subtracting a sum of values of signals of third and fourth photodetection devices from a sum of values of signals of first and second photodetection devices, in a direction in which the information recording medium rotates, from detection signals of a quadrant photodetector for detecting the servo spot, monitoring a time point when the shuttering signal reaches a zero level, and outputting a shuttering control signal instructing to capture the image stored in the information recording medium at a time point when the shuttering signal reaches a zero level.

The monitoring of a time point comprises monitoring a time point when the shuttering signal reaches a zero level in a section where the shuttering signal changes from a (+) value to a (−) value.

The first and second photodetection devices are two photodetection devices that come earlier in a direction in which the information recording medium rotates while the third and fourth photodetection devices are two photodetection devices that come later in a direction in which the information recording medium rotates.

According to another aspect of the present invention, an apparatus for controlling tracking of an information recording medium including an area for storing a holographic image and an area for storing servo spots formed discretely and at a predetermined interval comprises a photodetection unit obtaining an RF-SUM signal by adding all detection signals of quadrant photodetection devices for detecting the servo spot, and a servo control unit monitoring whether the RF-SUM signal exceeds a predetermined level and performing tracking control during a section wherein the RF-SUM signal exceeds the predetermined level.

According to another aspect of the present invention, an apparatus for controlling tracking of an information recording medium including an area for storing a holographic image and an area for storing servo spots formed discretely and at a predetermined interval comprises a photodetection unit obtaining a shuttering signal by subtracting a sum of values of signals of third and fourth photodetection devices from a sum of values of signals of first and second photodetection devices, in a direction in which the information recording medium rotates, from detection signals of a quadrant photodetector for detecting the servo spot, and a servo control unit monitoring whether the shuttering signal belongs to a predetermined section and performing tracking control during a period when the shuttering signal belongs to the predetermined section.

According to another aspect of the present invention, an apparatus for capturing a holographic image from an information recording medium including an area for storing a holographic image and an area for storing servo spots formed discretely and at a predetermined interval comprises a photodetection unit obtaining a shuttering signal by subtracting a sum of values of signals of third and fourth photodetection devices from a sum of values of signals of first and second photodetection devices, in a direction in which the information recording medium rotates, from detection signals of a quadrant photodetector for detecting the servo spot, and a shuttering control unit monitoring whether the shuttering signal reaches a zero level and instructing to capture the image stored in the information recording medium at a time point when the shuttering signal reaches the zero level.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating the format of storing a holographic image on an information recording medium according to a conventional technology;

FIG. 2 is a block diagram of an apparatus for reproducing a holographic image from an information recording medium according to an embodiment of the present invention;

FIG. 3 is a block diagram of a photodetection unit shown in FIG. 2;

FIG. 4 is a view showing a waveform of an RF-SUM signal shown in FIG. 3;

FIG. 5 is a view showing a waveform of a tracking error signal shown in FIG. 3;

FIG. 6 is a view showing a waveform of a shuttering signal shown in FIG. 3;

FIG. 7A is a view illustrating an example of a servo control unit of FIG. 2;

FIG. 7B is a waveform diagram for controlling tracking according to the servo control unit shown in FIG. 7A;

FIG. 8A is a view illustrating another example of a servo control unit of FIG. 2;

FIG. 8B is a waveform diagram for controlling tracking according to the servo control unit shown in FIG. 8A;

FIG. 9A is a view illustrating an example of a shuttering control unit of FIG. 2;

FIG. 9B is a waveform diagram for controlling shuttering according to the shuttering control unit shown in FIG. 9A;

FIG. 10 is a flow chart for explaining a method of controlling tracking according to an embodiment of the present invention;

FIG. 11 is a flow chart for explaining a method of controlling tracking according to another embodiment of the present invention; and

FIG. 12 is a flow chart for explaining a method of controlling shuttering according to an embodiment of the present invention.

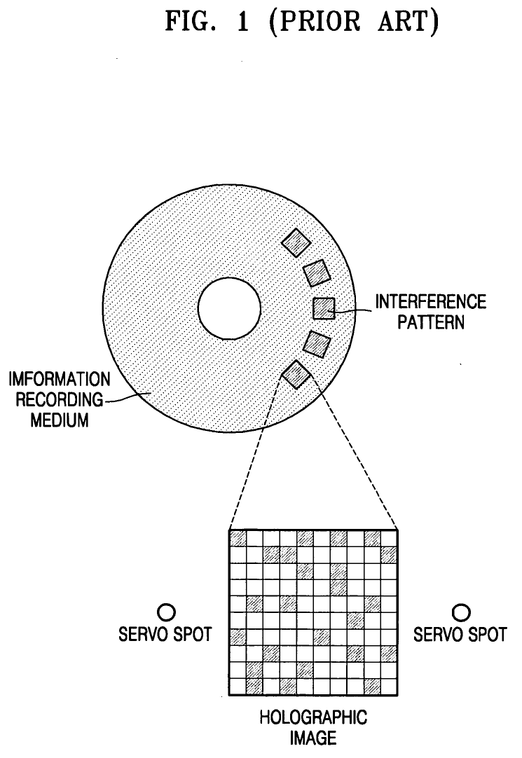

### DETAILED DESCRIPTION OF THE INVENTION

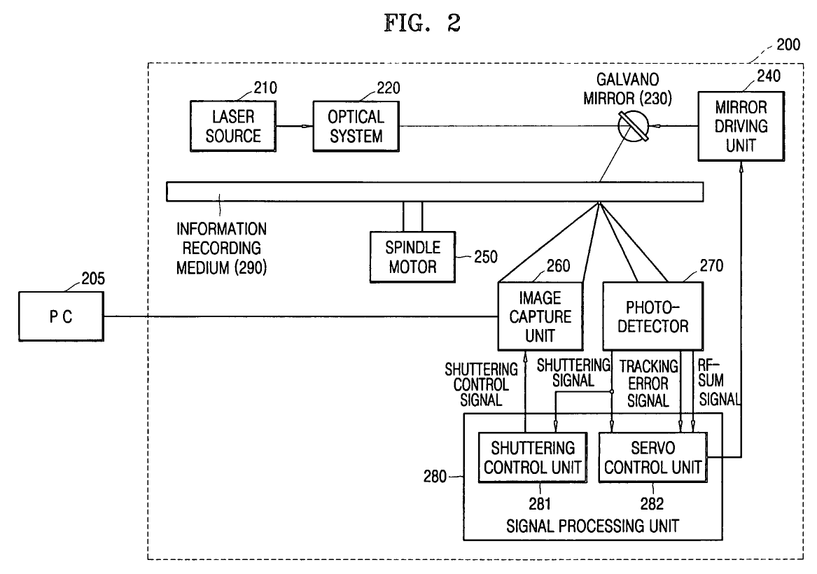

FIG. 2 is a block diagram of an apparatus for reproducing a holographic image from an information recording medium according to an embodiment of the present invention. Referring to FIG. 2, a reproduction apparatus 200 includes a laser source 210, an optical system 220, a Galvano mirror 230, a mirror driving unit 240, a spindle motor 250, an image capture unit 260, a photodetection unit 270, and a signal processing unit 280.

The laser source 210 emits a laser beam. The laser beam passes through the optical system 220 and is reflected by the Galvano mirror 230. Then, the laser beam passes through an information recording medium 290 and is projected onto the image capture unit 260 and the photodetection unit 270.

The photodetection unit 270 detects a servo spot and generates a tracking error signal, a shuttering signal, and an RF-SUM signal and provides the generated signals to the signal processing unit 280. The signal processing unit 280 receives the tracking error signal, the shuttering signal, and the RF-SUM signal provided from the photodetection unit 270 and outputs a signal for servo control and a signal for shuttering control to the mirror driving unit 240 and the image capture unit 260.

The signal processing unit 280 includes a shuttering control unit 281 and a servo control unit 282. The shuttering control unit 281 receives a shuttering signal from the photodetection unit 270, detects a predetermined time point, and provides a shuttering control signal to the image capture unit 260 at the time point. The servo control unit 282 receives the shuttering signal, the tracking error signal, and the RF-SUM signal from the photodetection unit 270, detects a predetermined section in the shuttering signal or RF-SUM signal, and corrects a tracking error signal using the result of the detection, thus performing tracking control. The shuttering control unit 281 and the servo control unit 282 according to the present embodiment are described below in detail.

The mirror driving unit 240 receives a tracking control signal to control the position of the Galvano mirror 230. The image capture unit 260 receives the shuttering control signal from the signal processing unit. When the shuttering control signal is received, the image capture unit 260 captures an image from the image recording medium 290 and outputs captured image data to a PC 205.

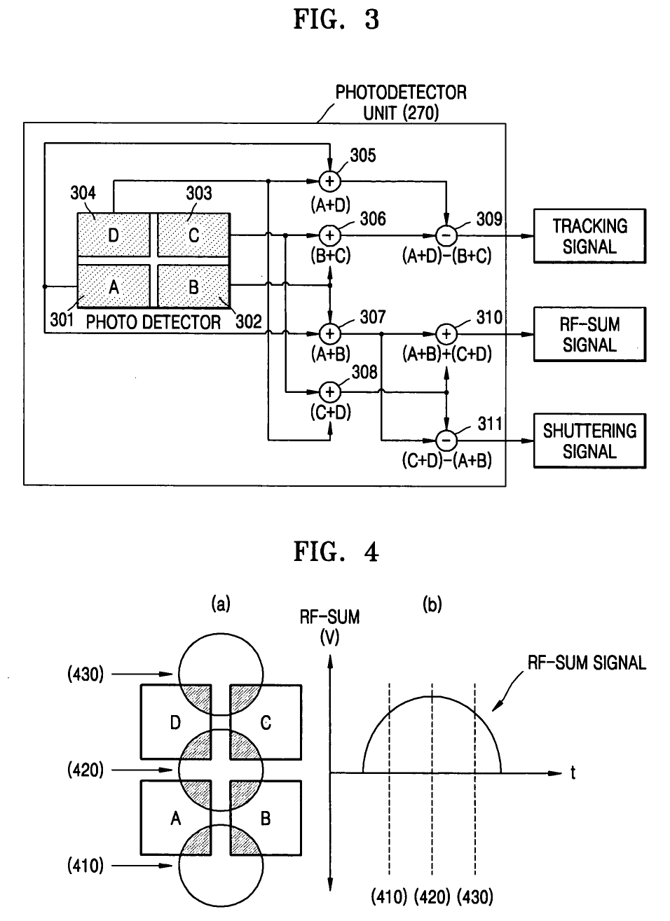

FIG. 3 is a block diagram illustrating a detailed structure of the photodetection unit shown in FIG. 2. Referring to FIG. 3, the photodetection unit 270 includes a first photodetection device 301, a second photodetection device 302, a third photodetection device 303, a fourth photodetection device 304, five adders 305, 306, 307, 308, and 310, and two subtracters 309 and 311.

The photodetection unit 270 converts the amount of a spot projected onto each photodetection device of a quadrant photodetector to an electrical signal, combines signals of the respective photodetection devices, and generates the tracking error signal, the shuttering signal, and the RF-SUM signal for servo.

In the following description, A, B, C, and D denote signals detected by the first through fourth photodetection devices 301-304, respectively.

The tracking error signal is expressed as (A+D)-(B+C) and is obtained as the subtracter 309 receives a signal (A+D) output by the adder 305 and a signal (B+C) output by the adder 306 and subtracts the signal (B+C) from the signal (A+D).

The RF-SUM signal is expressed as (A+B)+(C+D) and is obtained as the adder 310 receives a signal (A+B) output by the adder 307 and a signal (C+D) output by the adder 308 and adds the signal (A+B) to the signal (C+D).

The shuttering signal is expressed as (C+D)-(A+B) and is obtained as the subtracter 311 receives a signal (C+D) output by the adder 308 and a signal (A+B) output by the adder 307 and subtracts the signal (A+B) from the signal (C+D).

FIG. 4 shows a waveform of the RF-SUM signal shown in FIG. 3. A unit (a) of FIG. 4 shows positions 410, 420, and 430 of a servo spot passing across the photodetection devices 301, 302, 303, and 304. A unit (b) of FIG. 4 shows a waveform of the RF-SUM signal output as the servo spot passes across the photodetection devices.

Referring to the units (a) and (b) of FIG. 4, when the servo spot passes the position 410 halfway overlapping each of the photodetection devices 301 and 302, the signal RF-SUM has a value of a point on a curve indicated by the position 410 which is equivalent to a sum of an amount of the signal detected by the photodetection device 301 and an amount of the signal detected by the photodetection device 302.

When the servo spot passes the position 420 that is just the center of the photodetection devices 301, 302, 303, and 304, referring to the unit (b) of FIG. 4, the signal RF-SUM has value of a point on a curve indicated by the position 420 which is equivalent to a sum of the amounts of signals detected by the photodetection devices 301-304. At this time, the RF-SUM value indicates the maximum value.

When the servo spot passes the position 430 halfway overlapping each of the photodetection devices 303 and 304, referring to the unit (b) of FIG. 4, the signal RF-SUM has a value of a point on a curve indicated by the position 430 which is equivalent to a sum of an amount of the signal detected by the photodetection device 303 and an amount of the signal detected by the photodetection device 304.

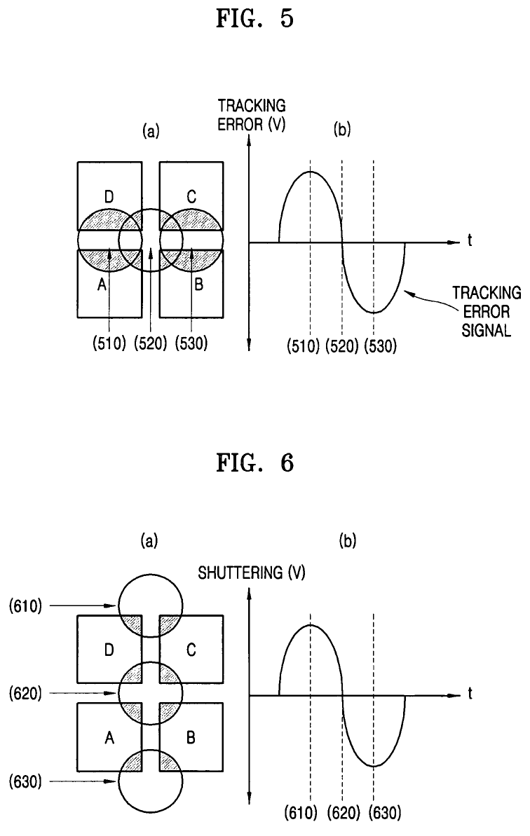

FIG. 5 shows a waveform of a tracking error signal shown in FIG. 3. A unit (a) of FIG. 5 shows positions 510, 520, and 530 of a servo spot passing across the photodetection devices 301, 302, 303, and 304. A unit (b) of FIG. 5 shows a waveform of the tracking error signal output as the servo spot passes across the photodetection devices.

Referring to the units (a) and (b) of FIG. 5, when the servo spot passes the position 510 halfway overlapping each of the photodetection devices 301 and 304, the tracking error signal has a value of a point on a curve indicated by the position 510. Since the tracking error signal is not detected from the photodetection devices 302 and 303, the value of the tracking error signal is equivalent to a sum of an amount of the signal detected by the photodetection device 301 and an amount of the signal detected by the photodetection device 304 which indicates the maximum value.

When the servo spot passes the position 520 that is just the center of the photodetection devices 301, 302, 303, and 304, referring to the unit (b) of FIG. 5, the tracking error signal has a value of a point on a curve indicated by the position 520. Since an amount of the signals detected by the photodetection devices 301 and 302 and an amount of the signals detected by the photodetection devices 303 and 304 are almost the same, the tracking error signal has a value close to 0.

When the servo spot passes the position 530 halfway overlapping each of the photodetection devices 302 and 303, referring to the unit (b) of FIG. 5, the tracking error signal has a value of a point on a curve indicated by the position 530. Since the signal is not detected from the photodetection devices 301 and 304, the tracking error signal has a value equivalent to the negative sum of an amount of the signal detected by the photodetection device 302 and an amount of the signal detected by the photodetection device 303 which indicates the minimum value.

FIG. 6 shows a waveform of a shuttering signal shown in FIG. 3. A unit (a) of FIG. 6 shows positions 610, 620, and 630 of a servo spot passing across the photodetection devices 301, 302, 303, and 304. A unit (b) of FIG. 6 shows a waveform of the shuttering signal output as the servo spot passes across the photodetection devices.

Referring to the units (a) and (b) of FIG. 6, when the servo spot passes the position 610 halfway overlapping each of the photodetection devices 303 and 304, the shuttering signal has a value of a point on a curve indicated by the position 610. Since the signal is not detected from the photodetection devices 301 and 302, the value of the shuttering signal is equivalent to a sum of an amount of the signal detected by the photodetection device 303 and an amount of the signal detected by the photodetection device 304 which indicates the maximum value.

When the servo spot passes the position 620 that is just the center of the photodetection devices 301, 302, 303, and 304, referring to the unit (b) of FIG. 6, the shuttering signal has a value of a point on a curve indicated by the position 620. Since an amount of the signals detected by the photodetection devices 301 and 302 and an amount of the signals detected by the photodetection devices 303 and 304 are almost the same, the shuttering signal has a value close to 0.

When the servo spot passes the position 630 halfway overlapping each of the photodetection devices 301 and 302, referring to the unit (b) of FIG. 6, the shuttering signal has a value of a point on a curve indicated by the position 630. Since the signals are not detected from the photodetection devices 303 and 304, the value of the shuttering signal is equivalent to the negative sum of an amount of the signal detected by the photodetection device 301 and an amount of the signal detected by the photodetection device 302, which indicates the minimum value.

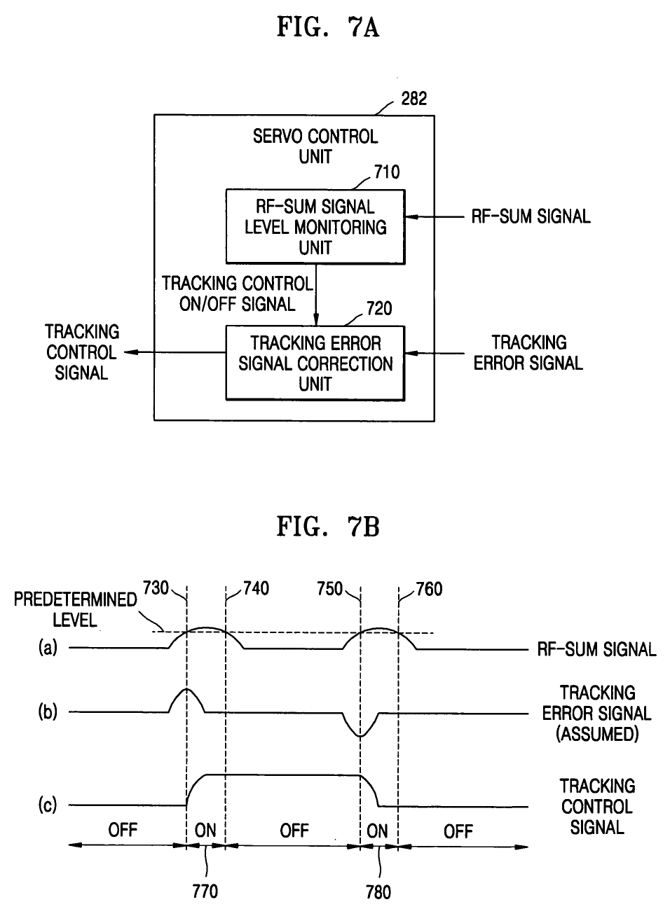

FIG. 7A illustrates an example of the servo control unit of FIG. 2. Referring to FIG. 7A, the servo control unit 282 includes an RF-SUM signal level monitoring unit 710 and a tracking error signal correction unit 720. The RF-SUM signal level monitoring unit 710 receives the RF-SUM signal from the photodetection unit 270 and monitors whether the value of the received RF-SUM signal exceeds a predetermined level. When it is detected during monitoring that the value of the RF-SUM signal exceeds the predetermined level, the RF-SUM signal level monitoring unit 710 provides a signal to start tracking control to the tracking error signal correction unit 720.

The tracking error signal correction unit 720 receives the tracking error signal from the photodetection unit 270. When a tracking control on signal is received from the RF-SUM signal level monitoring unit 710, the tracking error signal correction unit 720 generates a tracking control signal to correct the tracking error signal and outputs the generated tracking control signal to the mirror driving unit 240.

FIG. 7B is a waveform diagram for controlling tracking according to the example shown in FIG. 7A. Lines (a), (b), and (c) denote the RF-SUM signal, the tracking error signal, and the tracking control signal, respectively.

Referring to the line (a) of FIG. 7B, the RF-SUM signal has a gradually changing positive value in a section where the servo spot passes the photodetection device, and a value of “0” in a section where the servo spot does not pass the photodetection device. Since the servo spot is recorded discretely, not continuously, referring to the line (a) of FIG. 7B, on a track of the information recording medium, the RF-SUM signal has a predetermined value in a section where the servo spot and the photodetection device are overlapped and a value of “0” in the other section.

The RF-SUM signal level monitoring unit 710 performs tracking control in a section where the servo spot passes the photodetection device, in particular, in sections 770 and 780 where a value of the RF-SUM signal is over a predetermined level. Referring to the line (a), when it is detected that a value of the RF-SUM signal exceeds a predetermined level at a time point 730, the RF-SUM signal level monitoring unit 710 starts tracking control by turning on a signal for tracking control. When the tracking error signal indicates, for example, a (+) value, as indicated by the line (b), the tracking error signal correction unit 720 converts the tracking control signal to a (+) value to perform the tracking control as indicated by the line (c). When it is detected that the value of the RF-SUM signal is not more than the predetermined level at a time point 740, the RF-SUM signal level monitoring unit 710 terminates the tracking control by turning off the signal for tracking control so that the tracking control is not performed in a section between the time points 740 and 750. That is, when the RF-SUM signal is under a predetermined level, the tracking control is turned off and a level of a control signal at this time is maintained to be uniform so that the position of the Galvano mirror is fixed.

Next, in the section 780 where the servo spot passes the photodetection device, the tracking control is performed likewise. However, when the tracking error signal indicates, for example, a (−) value, as indicated by the line (b), the tracking error signal correction unit 720 converts the value of the tracking control signal to be (-) as indicated by the line (c) to perform the tracking control.

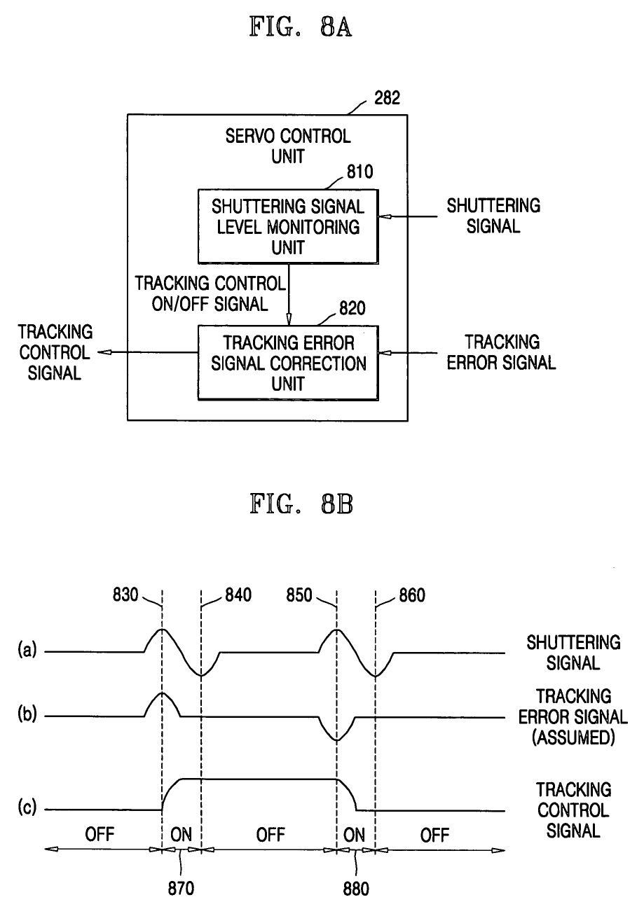

FIG. 8A illustrates another example of the servo control unit of FIG. 2. Referring to FIG. 8A, the servo control unit includes a shuttering signal level monitoring unit 810 and a tracking error signal correction unit 820. The shuttering signal level monitoring unit 810 receives a shuttering signal from the photodetection unit 270 and monitors whether a value of the received shuttering signal belongs to a predetermined section. When it is detected during monitoring that the value of the received shuttering signal belongs to the predetermined section, the shuttering signal level monitoring unit 810 provides a signal for starting tracking control to the tracking error signal correction unit 820.

The tracking error signal correction unit 820 receives a tracking error signal from the photodetection unit. When a tracking error on signal is received from the shuttering signal level monitoring unit 810, the tracking error signal correction unit 820 generates a tracking control signal to correct the tracking error signal and outputs the generated tracking control signal to the mirror driving unit 240.

FIG. 8B is a waveform diagram for controlling tracking according to the servo control unit shown in FIG. 8A. Lines (a), (b), and (c) denote the shuttering signal, the tracking error signal, and the tracking control signal, respectively.

Referring to the line (a) of FIG. 8B, the shuttering signal has a shape similar to a sine wave changing from a (+) value to a (−) value in a section where the servo spot passes the photodetection device and a value of “0” in a section where the servo spot does not pass the photodetection device. Since the servo spot is recorded discretely, not continuously, on a track of the information recording medium, referring to the line (a), the shuttering signal has a predetermined value in a section where the servo spot and the photodetection device are overlapped and a value of “0” in the other section.

The tracking error signal correction unit 820 performs tracking control in a section where the servo spot passes the photodetection device, in particular, in sections 870 and 880 where a value of the shuttering signal belongs to a predetermined section. Referring to the line (a), when it is detected that a value of the shuttering signal belongs to a predetermined section at a time point 830, the shuttering signal level monitoring unit 810 starts tracking control by turning on a signal for tracking control. When the tracking error signal indicates, for example, a (+) value, as indicated by the line (b), the tracking error signal correction unit 820 converts the tracking control signal to a (+) value to perform the tracking control as indicated by the line (c). When it is detected that the value of the shuttering signal escapes from the predetermined section at a time point 840, the shuttering signal level monitoring unit 810 terminates the tracking control by turning off the signal for tracking control so that the tracking control is not performed in a section between the time points 840 and 850. That is, the tracking control is turned off in the section between the time points 840 and 850 and a level of a control signal at this time is maintained so that the position of the Galvano mirror is fixed.

Next, in the section 880 where the servo spot passes the photodetection device, the tracking control is performed likewise. However, when the tracking error signal indicates, for example, a (−) value, as indicated by the line (b), the tracking error signal correction unit 820 converts the value of the tracking control signal to be (−) as indicated by the line (c) to perform the tracking control.

In the line (a), the predetermined section of the shuttering signal where tracking control is performed is from a time point indicating the maximum value of the shuttering signal to a time point indicating a minimum value of the shuttering signal. The predetermined section for tracking control is not limited to the section from a time point indicating the maximum value of the shuttering signal to a time point indicating a minimum value of the shuttering signal, but can be any section in which the value of the shuttering signal changes.

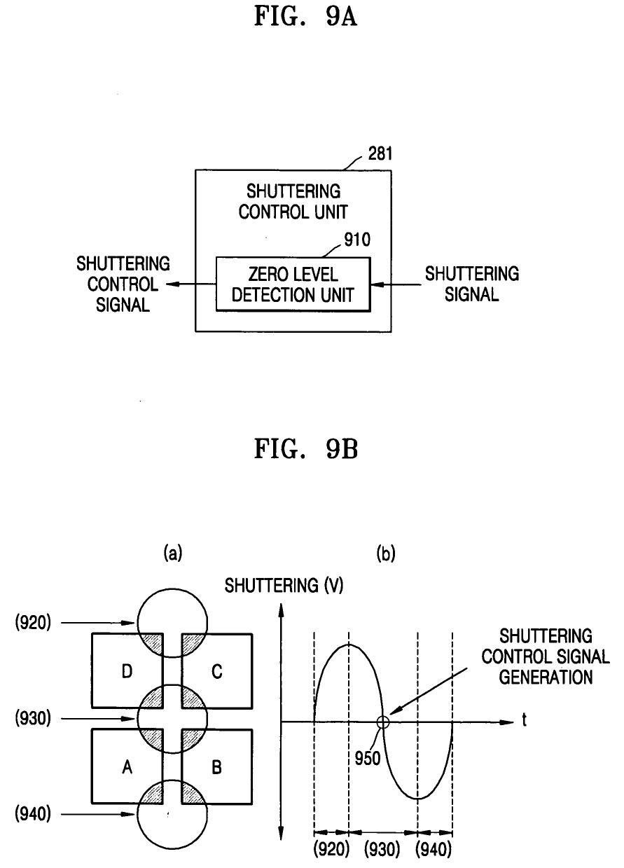

FIG. 9A illustrates an example of the shuttering control unit 281 of FIG. 2. Referring to FIG. 9A, the shuttering control unit 281 includes a zero level detection unit 910. The zero level detection unit 910 receives a shuttering signal from the photodetection unit 270 and monitors whether the value of the received shuttering signal is at a zero level. When the value of the shuttering signal is detected to be at the zero level during monitoring, the zero level detection unit 910 outputs a shuttering control signal to the image capture unit 260.

FIG. 9B is a wave diagram for controlling shuttering according to the shuttering control unit 281 shown in FIG. 9A. A unit (a) of FIG. 9B shows positions 920, 930, and 940 of a servo spot passing across the photodetection devices 301, 302, 303, and 304. A unit (b) of FIG. 9B shows a waveform of the shuttering signal output as the servo spot passes across the photodetection devices.

As described above with reference to FIG. 8B, the shuttering signal has a shape similar to a sine wave changing from a (+) value to a (−) value in a section in which the servo spot passes across the photodetection devices and has a value “0” in a section where the servo stop does not pass the photodetection devices.

Since it is preferable to obtain an image when the servo spot is located just at the center of the photodetection devices, the zero level detection unit 910 detects a time point where the value of the shuttering value becomes zero in a section where the servo spot passes across the photodetection devices, that is, the value of the shuttering signal changes from a (+) value to a (−) value, and outputs a shuttering control signal at the detected time point.

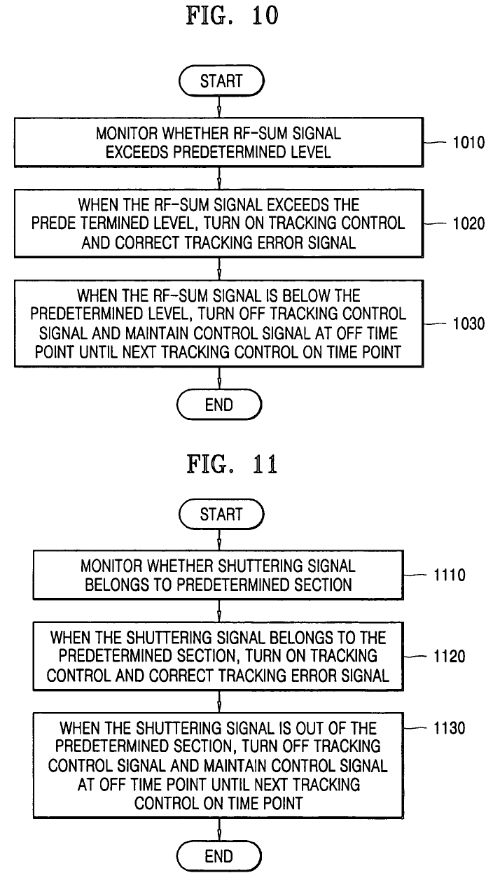

FIG. 10 is a flow chart for explaining a method of controlling tracking according to an embodiment of the present invention. Referring to FIG. 10, when the photodetection unit 270 receives a signal projected from the information recording medium 290 and outputs an RF-SUM signal, the RF-SUM signal level monitoring unit 710 of the servo control unit 282 according to the present embodiment monitors whether the value of the RF-SUM signal exceeds a predetermined level (1010).

When the RF-SUM signal is detected to exceed the predetermined level, the RF-SUM signal level monitoring unit 710 transmits a signal to the tracking error signal correction unit 720 to start tracking control. Then, the tracking error signal correction unit 720 corrects the tracking error signal (1020). The tracking error signal correction unit 720 turns off the tracking control signal when the RF-SUM signal is not more than the predetermined level (1030).

FIG. 11 is a flow chart for explaining a method of controlling tracking according to another embodiment of the present invention. Referring to FIG. 11, when the photodetection unit 270 receives a signal projected from the information recording medium 290 and outputs a shuttering signal, the shuttering signal level monitoring unit 810 of the servo control unit 282 according to the present invention monitors whether the value of the shuttering signal exceeds a predetermined level (1110). The predetermined section is from a time point indicating the maximum value of the shuttering signal to a minimum value of the shuttering signal.

When the shuttering signal is detected to belong to the predetermined section, the shuttering signal level monitoring unit 810 transmits a signal to the tracking error signal correction unit 820 to start tracking control. Then, the tracking error signal correction unit 820 corrects the tracking error signal (1120). The tracking error signal correction unit 820 turns off the tracking control signal when the shuttering signal is out of the predetermined section (1130).

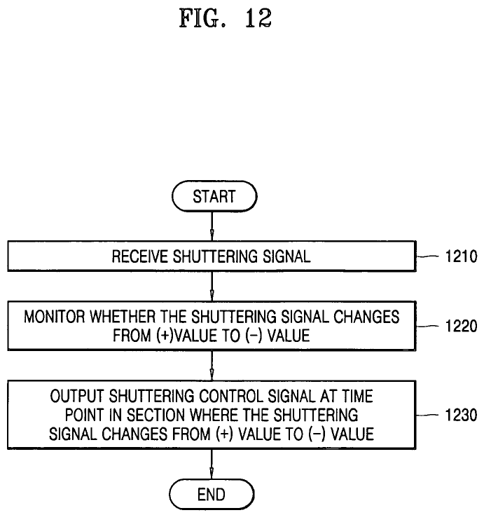

FIG. 12 is a flow chart for explaining a method of controlling shuttering according to an embodiment of the present invention. Referring to FIG. 12, when the photodetection unit 270 receives a signal projected from the information recording medium 290 and outputs a shuttering signal, the zero level detection unit 910 of the shuttering control unit 281 according to the present embodiment receives the shuttering signal (1210).

The zero level detection unit 910 monitors whether the value of the shuttering signal reaches a zero point in a section where the value of the shuttering signal changes from a (+) value to a (−) value (1220). The zero level detection unit 910 outputs a shuttering control signal to the image capture unit 260 at a time point when the shuttering signal changes from a (+) value to a (−) value (1230).

While this invention has been particularly shown and described with reference to exemplary embodiments thereof, it will be understood by those skilled in the art that various changes in form and details may be made therein without departing from the spirit and scope of the invention as defined by the appended claims.

As described above, according to the present invention, two dimensional information can be accurately reproduced from the image recording medium containing a holographic image, through the tracking control and the shuttering signal.

What is claimed is:

1. A method of controlling tracking of an information recording medium including an area for storing a holographic image and an area for storing servo spots formed discretely and at a predetermined interval, the method comprising:
obtaining an RF-SUM signal by adding all of detection signals of a quadrant photodetector for detecting the servo spot;
monitoring whether the RF-SUM signal exceeds a predetermined level; and
performing tracking control in a section where the RF-SUM signal exceeds the predetermined level.

2. The method as claimed in claim 1, further comprising turning off the tracking control when the RF-SUM signal is not more than the predetermined level.

3. A method of controlling tracking of an information recording medium including an area for storing a holographic image and an area for storing servo spots formed discretely and at a predetermined interval, the method comprising:
obtaining a shuttering signal by subtracting a sum of values of signals of third and fourth photodetection devices from a sum of values of signals of first and second photodetection devices, in a direction in which the information recording medium rotates, from detection signals of a quadrant photodetector for detecting the servo spot;
monitoring whether the shuttering signal belongs to a predetermined section; and
performing tracking control in a section where the shuttering signal belongs to the predetermined section.

4. The method as claimed in claim 3, wherein the predetermined section includes a section from a time point indicating a maximum value of the shuttering signal to a time point indicating a minimum value of the shuttering signal.

5. The method as claimed in claim 3, further comprising turning off the tracking control when the shuttering signal is out of the predetermined section.

6. A method of capturing a holographic image from an information recording medium including an area for storing a holographic image and an area for storing servo spots formed discretely and at a predetermined interval, the method comprising:
obtaining a shuttering signal by subtracting a sum of values of signals of third and fourth photodetection devices from a sum of values of signals of first and second photodetection devices, in a direction in which the information recording medium rotates, from detection signals of a quadrant photodetector for detecting the servo spots;
monitoring a time point when the shuttering signal reaches a zero level; and
outputting a shuttering control signal instructing capture of the image stored in the information recording medium at a time point when the shuttering signal reaches a zero level.

7. The method as claimed in claim 6, wherein the monitoring of a time point comprises monitoring a time point when the shuttering signal reaches a zero level in a section where the shuttering signal changes from a (+) value to a (−) value.

8. The method as claimed in claim 6, wherein the first and second photodetection devices are two photodetection devices that come earlier in a direction in which the information recording medium rotates while the third and fourth photodetection devices are two photodetection devices that come later in a direction in which the information recording medium rotates.

9. An apparatus for controlling tracking of an information recording medium including an area for storing a holographic image and an area for storing servo spots formed discretely and at a predetermined interval, the apparatus comprising:
a photodetection unit obtaining an RF-SUM signal by adding all detection signals of a quadrant photodetection devices for detecting the servo spots; and
a servo control unit monitoring whether the RF-SUM signal exceeds a predetermined level and performing tracking control during a section wherein the RF-SUM signal exceeds the predetermined level.

10. The apparatus as claimed in claim 9, wherein, when the RF-SUM signal is not more than the predetermined level, the servo control unit turns off the tracking control and maintains a control value at the time point when the tracking control is turned off until a time point when a next control section starts.

11. An apparatus for controlling tracking of an information recording medium including an area for storing a holographic image and an area for storing servo spots formed discretely and at a predetermined interval, the apparatus comprising:
a photodetection unit obtaining a shuttering signal by subtracting a sum of values of signals of third and fourth photodetection devices from a sum of values of signals of first and second photodetection devices, in a direction in which the information recording medium rotates, from detection signals of a quadrant photodetector for detecting the servo spots; and
a servo control unit monitoring whether the shuttering signal belongs to a predetermined section and performing tracking control during a period when the shuttering signal belongs to the predetermined section.

12. The apparatus as claimed in claim 11, wherein the predetermined section includes a section from a time point indicating a maximum value of the shuttering signal to a time point indicating a minimum value of the shuttering signal.

13. The apparatus as claimed in claim 11, wherein, when the shuttering signal is out of the predetermined section, the servo control unit turns off the tracking control and maintains a control value at the time point when the tracking control is turned off until a time point when a next control section starts.

14. An apparatus for capturing a holographic image from an information recording medium including an area for storing a holographic image and an area for storing servo spots formed discretely and at a predetermined interval, the apparatus comprising:
a photodetection unit obtaining a shuttering signal by subtracting a sum of values of signals of third and fourth photodetection devices from a sum of values of signals of first and second photodetection devices, in a direction in which the information recording medium rotates, from detection signals of a quadrant photodetector for detecting the servo spots; and
a shuttering control unit monitoring whether the shuttering signal reaches a zero level and instructing to capture the image stored in the information recording medium at a time point when the shuttering signal reaches the zero level.

15. The apparatus as claimed in claim 14, wherein the shuttering control unit monitors a time point when the shuttering signal reaches a zero level in a section where the shuttering signal changes from a (+) value to a (−) value.

16. The apparatus as claimed in claim 14, wherein the first and second photodetection devices are two photodetection devices that come earlier in a direction in which the information recording medium rotates while the third and fourth photodetection devices are two photodetection devices that come later in a direction in which the information recording medium rotates.
